(19) United States
(12) Patent Application Publication
(10) Pub. No.: US 2002/0147624 A1
(43) Pub. Date: Oct. 10, 2002

(54) System of supporting development of business process

(75) Inventors: Kazuki Yoshida, Tokyo-To (JP); Ryuichi Hosoya, Tokyo-To (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: KABUSHIKI KAISHA TOSHIBA, Tokyo-To (JP)

(21) Appl. No.: 10/011,754

(22) Filed: Dec. 11, 2001

(30) Foreign Application Priority Data
Dec. 12, 2000 (JP) 2000-377419

(51) Int. Cl. G06F 17/60

(52) U.S. Cl. 705/8; 705/7

(57) ABSTRACT

There is provided a system of supporting a development of a business process, adapted to easily carry out the development and maintenance of a business process. In a canvas region 32 on a tool display 30, icons 34a and 35a, structure lines 36 and control lines 37 are linked to connect a plurality of processing elements (basic control elements, custom processing elements, normal execution sequence elements and special execution sequence elements) to model a process flow in the business process as a tree structure. In the basic control elements, basic control flows of a series of business processing executed in the business process are implemented. In the custom processing elements, the separate functions of the series of business processing executed in the business process are implemented independent of the basic control elements. The normal execution sequence elements connect the basic control elements to each other and connect the same to the custom processing elements in a tree to form a regular execution route. The special execution sequence elements form an irregular execution route which does not comply with the regular execution route and which is determined on the basis of an event occurring in each of the basic control elements or custom processing elements.

### BACKGROUND OF THE INVENTION

1. Field of the Invention

The present invention generally relates to a technique for developing a business process. More specifically, the invention relates to a system for developing a business process by connecting a plurality of processing elements (software components).

2. Description of Related Art

The business process is a process for realizing the flow (the process flow) of a series of business processing for carrying out integrated business affairs. For example, in a client/server system having a two-layer type system configuration, a business process is incorporated into a client-side program that is implemented by the Visual Basic of Microsoft Company, or the like. On the other hand, in a Webtop type application system that is widely used with the spread of Internet in recent years, a business process exists as link data for linking pages of HTML documents or the like.

In recent years, in client/server systems and Webtop type application systems, a three-layer type system configuration including a presentation layer, a business logic layer and a data base layer is widely spread. In such a three-layer type system, a business process and business services (concrete processes executed in the business process) are incorporated into the business logic layer. Furthermore, as can be seen from the specification of the EJB (Enterprise JavaBeans), the business logic layer including a business process is implemented on a server together with the data base layer. A part of the business logic layer may be implemented on a client.

Thus, the business process implemented in the client/server system or Webtop type application system often has a complicated structure in accordance with the kind and configuration of a system to be implemented, so that it is desired to cause the business process to be divided into a plurality of components so as to clarify the process flow of the business process and to efficiently carry out the development (modeling, generation, execution of function, etc.) of the business process. Particularly in the above-described conventional Webtop type application systems, the business process is distributed in a plurality of HTML documents as link data for linking their pages, so that the whole structure of the business process cannot be clearly discriminated. Therefore, there is a problem in that it is not possible to easily carry out the development and maintenance of the business process, and it is requested to provide means for effectively solving this problem.

### SUMMARY OF THE INVENTION

The present invention has been made in view of the above-described point. It is therefore an object of the present invention to provide a system of supporting a development of a business process, a method and a program of carrying out the same, which are adapted to easily carry out the development and maintenance of a business process.

According to a first aspect of the present invention, there is provided a system of supporting a development of a business process that executes a series of business processing. The system comprises: a business process configuration part for modeling a process flow in the business process by connecting a plurality of processing elements, to output a process definition data as a result of the modeling; and a business process generating part for generating an executable processing model by using the process definition data outputted from the business process configuration part. The plurality of processing elements include a plurality of basic control elements in which basic control flows of the series of business processing executed in the business process are implemented, and a plurality of custom processing elements in which separate functions of the series of business processing executed in the business process are implemented. The business process configuration part models the process flow in the business process by forming a regular execution route through connecting the basic control elements to each other and connecting the basic control elements to the custom processing elements in a form of a tree, and by forming an irregular execution route that does not comply with the regular execution route and is determined on the basis of an event occurring in the basic control elements or the custom processing elements.

Preferably, in the above-described first aspect, the plurality of processing elements further include a plurality of normal execution sequence elements for forming the regular execution route, and a plurality of special execution sequence elements for forming the irregular execution route; and the business process configuration part models the process flow in the business process by connecting the normal execution sequence elements and the special execution sequence elements together with the basic control elements and the custom processing elements. In addition, the plurality of basic control elements preferably comprise an action control element for executing a custom processing element connected thereto; a procedure element for executing a plurality of other basic control elements connected thereto in a predetermined sequence; and a repeating procedure element for repeatedly executing a plurality of other basic control elements connected thereto in a predetermined sequence. Moreover, it is preferred that the plurality of basic control elements further comprise a branch element for selecting and executing an element as a branch destination among a plurality of other basic control elements connected thereto; and an external model calling element for calling and executing another processing model. Furthermore, the business process configuration part preferably presents the plurality of processing elements as icons on a tool display, and models the process flow in the business process in accordance with various connecting operations to icons carried out by a user.

According to a second aspect of the present invention, there is provided a method of supporting a development of a business process that executes a series of business processing. The method comprises the steps of: preparing, as a plurality of processing elements for modeling a process flow in the business process, a plurality of basic control elements in which basic control flows of the series of business processing executed in the business process are implemented, and a plurality of custom processing elements in which separate functions of the series of business processing executed in the business process are implemented; modeling the process flow in the business process by forming a regular execution route through connecting the basic control elements to each other and connecting the basic control elements to the custom processing elements in a form of a tree, and by forming an irregular execution route that does not comply with the regular execution route and is determined on the basis of an event occurring in the basic control elements or the custom processing elements; and outputting, as a process definition data, information relating to declarations for integrating the processing elements and relationship between the processing elements.

Furthermore, it is preferred that the method in the above-described second aspect further comprises the step of generating an executable processing model by using the outputted process definition data.

According to a third aspect of the present invention, there is provided a computer-readable recording medium in which a program of supporting a development of a business process that executes a series of business processing is recorded. The program causes a computer to perform the steps of: preparing, as a plurality of processing elements for modeling a process flow in the business process, a plurality of basic control elements in which basic control flows of the series of business processing executed in the business process are implemented, and a plurality of custom processing elements in which separate functions of the series of business processing executed in the business process are implemented; modeling the process flow in the business process by forming a regular execution route through connecting the basic control elements to each other and connecting the basic control elements to the custom processing elements in a form of a tree, and by forming an irregular execution route that does not comply with the regular execution route and is determined on the basis of an event occurring in the basic control elements or the custom processing elements; and outputting, as a process definition data, information relating to declarations for integrating the processing elements and relationship between the processing elements.

Furthermore, it is preferred that the program in the above-described third aspect of the present invention further causes the computer to perform the step of generating an executable processing model by using the outputted process definition data.

According to the present invention, a process flow in a business process is modeled by connecting processing elements (basic control elements, custom processing elements, normal execution sequence elements and special execution sequence elements, etc.) which are formed as components, and an executable processing model is generated on the basis of such modeling. Therefore, it is possible to model the process flow in the business process in a visualized manner, and it is possible to directly generate and execute the business process without the need of particularly additional implementations for the modeled business process. For that reason, it is possible to efficiently carry out the development and maintenance of the business process.

### BRIEF DESCRIPTION OF THE DRAWINGS

FIG. 1 is a block diagram showing a preferred embodiment of a business process development support system according to the present invention;

FIG. 2 is a diagram showing an example of a processing model for a business process, which is developed by the business process development support system shown in FIG. 1;

FIGS. 3A and 3B are diagrams for explaining the function of an action control element which is one type of basic control elements included in the processing model shown in FIG. 2;

FIG. 4 is a diagram for explaining the function of a procedure element which is one type of basic control elements included in the processing model shown in FIG. 2;

FIGS. 5A and 5B are diagrams for explaining the function of a repeating procedure element which is one type of basic control elements included in the processing model shown in FIG. 2;

FIG. 6 is a diagram for explaining the function of a branch element which is one type of basic control elements included in the processing model shown in FIG. 2;

FIG. 7 is a diagram for explaining the function of an exception handler element which is one type of custom processing elements included in the processing model shown in FIG. 2;

FIG. 8 is a diagram for explaining the function of a control line for “retract,” which is one type of control lines included in the processing model shown in FIG. 2;

FIG. 9 is a diagram for explaining the function of a control line for “break,” which is one type of control lines included in the processing model shown in FIG. 2;

FIG. 10 is a diagram for explaining the function of a control line for “reverse break,” which is one type of control lines included in the processing model shown in FIG. 2;

FIG. 11 is a diagram for explaining the function of a control line for “re-execute,” which is one type of control lines included in the processing model shown in FIG. 2;

FIG. 12 is a diagram for explaining the function of a control line for “jump,” which is one type of control lines included in the processing model shown in FIG. 2;

FIG. 13 is a diagram for explaining processing for modeling a business process in the business process development support system shown in FIG. 1;

FIG. 14 is a diagram for explaining processing for executing the function of a business process in the business process development support system shown in FIG. 1;

FIG. 15 is a diagram for explaining a method for managing a call sequence of a basic control element and a custom processing element by a stack during processing for executing the function of a business process;

FIG. 16 is a diagram for explaining the behavior of a stack during “retract” processing which is carried out in an irregular execution route;

FIG. 17 is a diagram for explaining the behavior of a stack during “break” processing which is carried out in an irregular execution route;

FIG. 18 is a diagram for explaining the behavior of a stack during “reverse break” processing which is carried out in an irregular execution route;

FIG. 19 is a diagram for explaining the behavior of a stack during “re-execute” processing which is carried out in an irregular execution route;

FIG. 20 is a diagram for explaining the behavior of a stack during “jump” processing which is carried out in an irregular execution route; and

FIG. 21 is a block diagram showing an example of a computer system in which a business process development support system according to the present invention is installed.

### DETAILED DESCRIPTION OF THE PREFERRED EMBODIMENTS

Referring now to the accompanying drawings, a preferred embodiment of the present invention will be described below.

A business process development support system in this preferred embodiment is provided for developing a business process that executes a series of business processing, and is adapted to model a process flow in the business process by connecting a plurality of processing elements (software components) to generate an executable processing model on the basis of the results thereof.

The business process is a process for realizing the flow (the process flow) of a series of business processing for carrying out integrated business affairs. For example, in the case of application form registration affairs (affairs to confirm and register the contents of an unregistered application form) which are required for a system of receiving an order entry for goods and so forth, the business process is defined as the flow of a series of business processing including the retrieval, reading, editing and registration of an application form. In this preferred embodiment, such a business process is modeled by connecting the following four kinds of processing elements (basic control elements, custom processing elements, normal execution sequence elements and special execution sequence elements).

Outline of Processing Model

First, in order to facilitate understanding of the business process development support system in this preferred embodiment, the outline of four kinds of processing elements (basic control elements, custom processing elements, normal execution sequence elements and special execution sequence elements), which form the basis for the modeling of a business process, will be described below. Furthermore, the “processing element” corresponds to each of software components constituting an executable processing model. When an object-oriented language is used for developing an executable processing model, each of processing elements corresponds to an instance of a class.

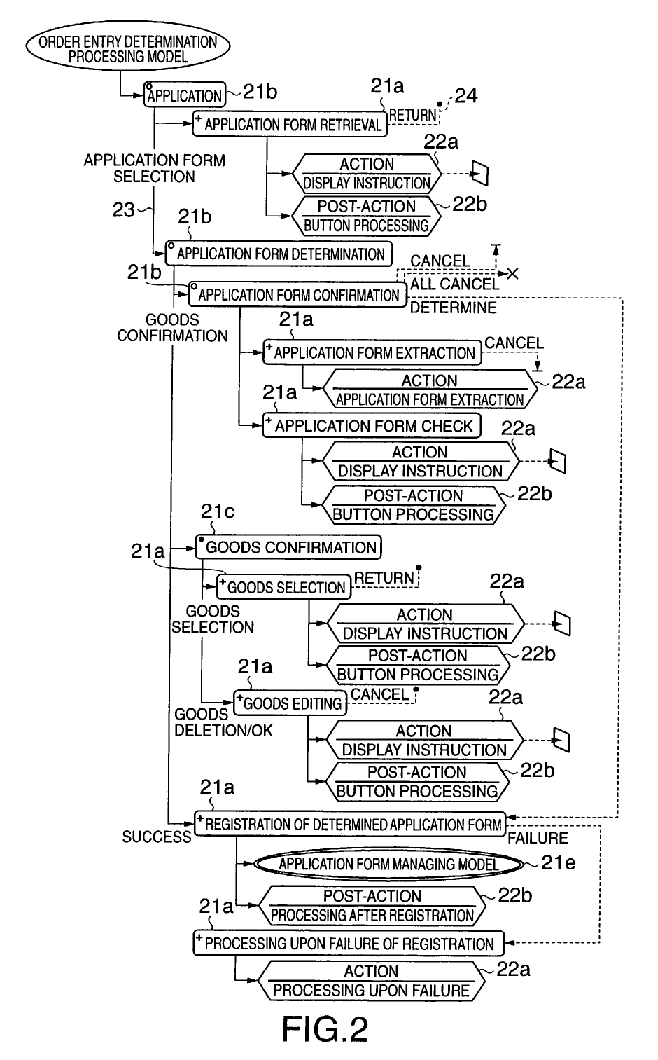

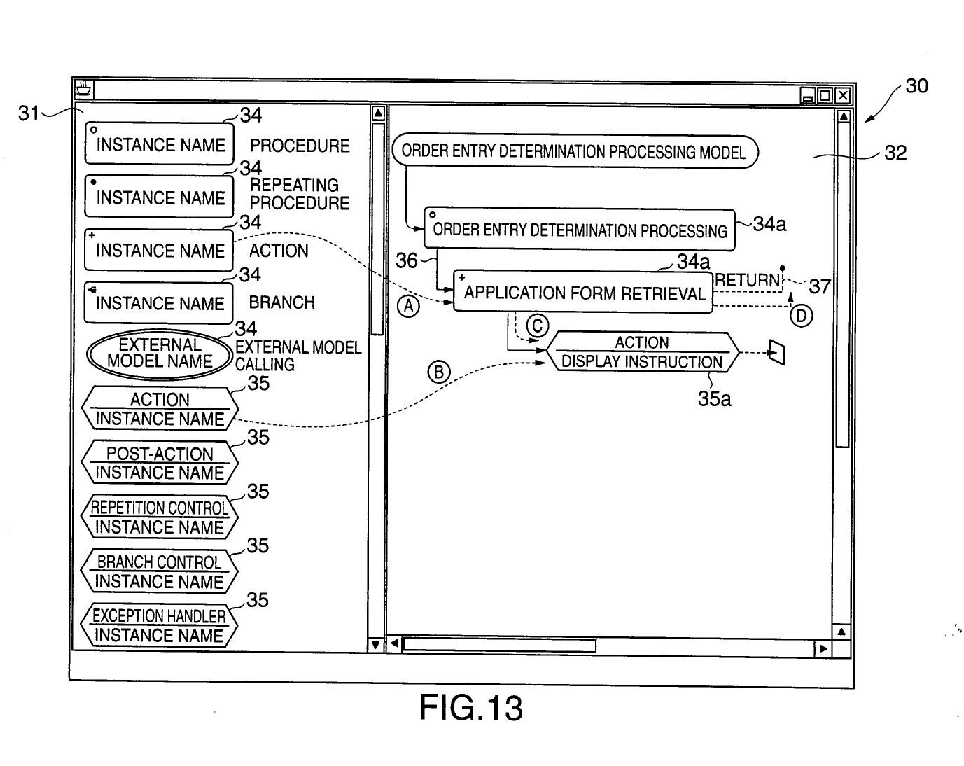

FIG. 2 is a diagram showing an example of a processing model for a business process which is developed by the business process development support system in this preferred embodiment. In the processing model shown in FIG. 2, notation for each of processing elements is the same as notation used for icons and so forth on a tool display 30 shown in FIG. 13.

As shown in FIG. 2, this processing model (an order entry determination processing model) includes a plurality of basic control elements (shown by substantially rectangular blocks (see reference numbers 21a, 21b and 21c) or elliptical blocks (see reference number 21e) in the figure), a plurality of custom processing elements (shown by hexagonal blocks (see reference numbers 22a and 22b) in the figure), normal execution sequence elements 23 (shown by solid lines in the figure) for forming regular execution routes, and special execution sequence elements 24 (shown by dotted lines in the figure) for forming irregular execution routes which do not comply with regular execution routes.

First, the basic control elements will be described below.

Each of the basic control elements is an element in which a basic control flow of the series of business processing executed in a business process is implemented. The basic control elements include the following five kinds of elements.

(1) Action Control Element

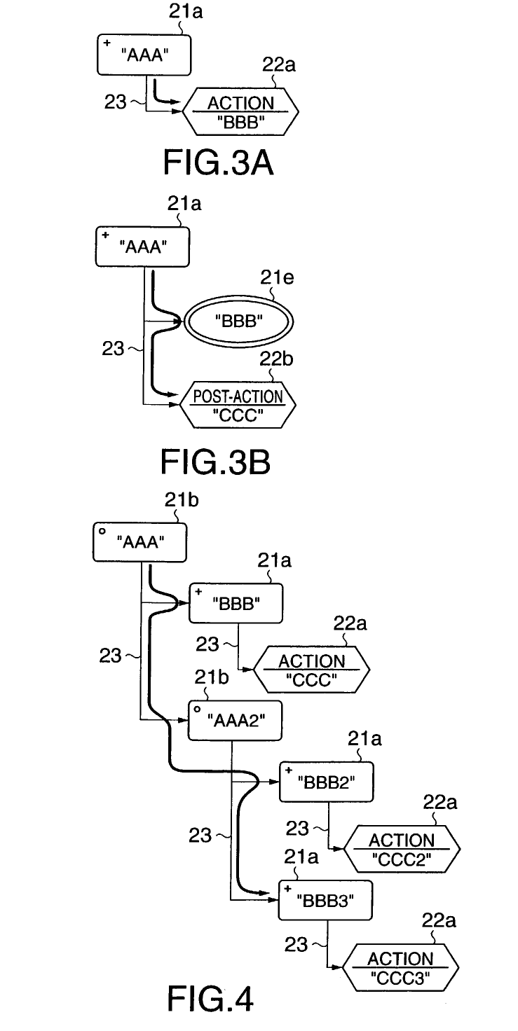

The action control element corresponds to an element to which reference number 21a is given in FIG. 2. The action control element is designed to execute a custom processing element which is connected thereto. As shown in FIGS. 3A and 3B, an action element 22a serving as a custom processing element or an external model calling element 21e (the details of which will be described later) serving as a basic control element is connected to the action control element 21a. Furthermore, as shown in FIG. 3B, a post-action element 22b (the details of which will be described later) serving as a custom processing element may be connected to the action control element 21a, together with the action element 22a or the external model calling element 21e.

(2) Procedure Element

The procedure element corresponds to an element to which reference number 21b is given in FIG. 2. The procedure element is designed to execute another basic control element (or a custom processing element if necessary), which is connected thereto, in a predetermined sequence. As shown in FIG. 4, a plurality of other basic control elements (the action control element 21a and another procedure element 21b) are connected to the procedure element 21b, and a series of these basic control elements are sequentially executed from the top.

(3) Repeating Procedure Element

The repeating procedure element corresponds to an element to which reference number 21c is given in FIG. 2.

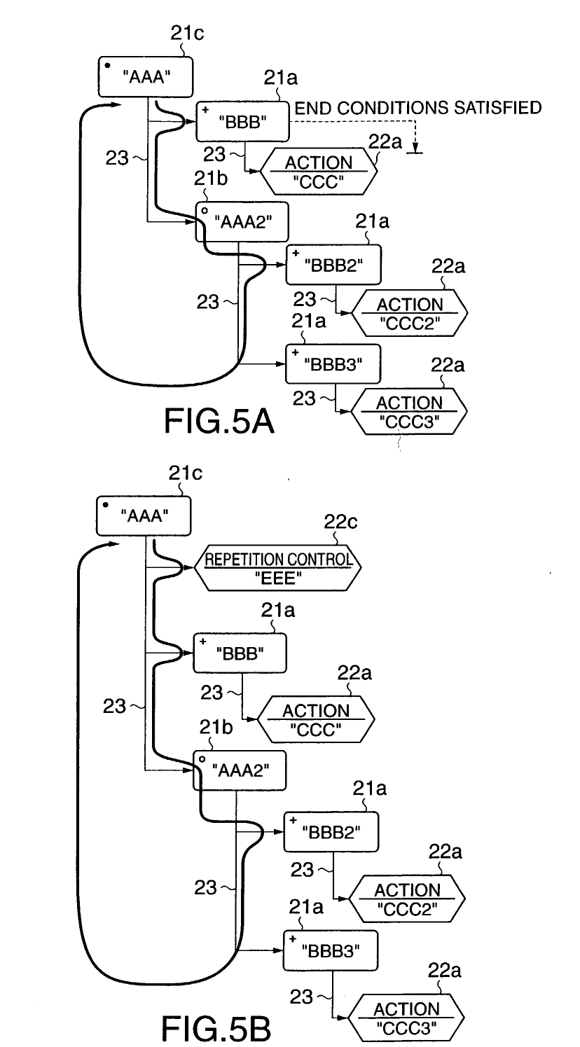

The repeating procedure element is designed to repeatedly execute a plurality of other basic control elements which are connected thereto. As shown in FIGS. 5A and 5B, a plurality of other basic control elements (an action control element 21a and a procedure element 21b) are connected to the repeating procedure element 21c, and a series of these basic control elements are sequentially and repeatedly executed from the top. FIGS. 5A and 5B respectively show a case where the repetition control element 22c (the details of which will be described later) serving as a custom processing element is not connected to the repeating procedure element 21c (FIG. 5A); and a case where the repetition control element 22c is connected to the repeating procedure element 21c (FIG. 5B).

(4) Branch Element

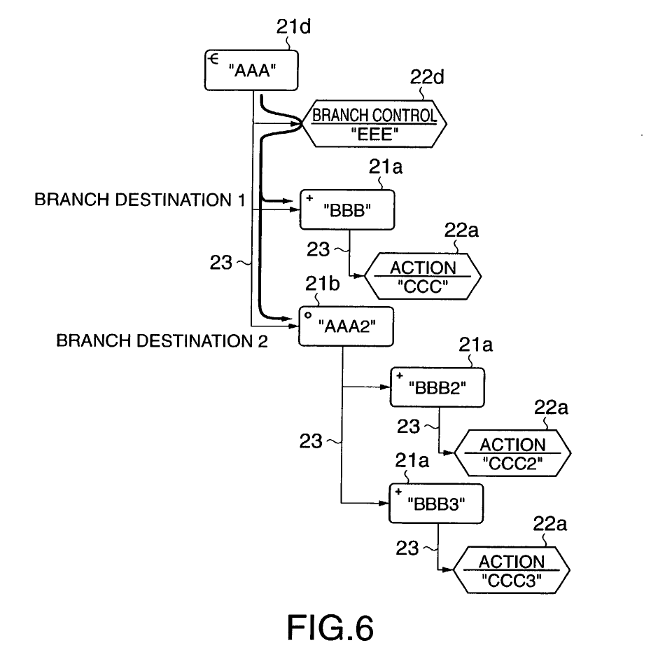

The branch element is designed to select and execute an element as a branch destination among a plurality of other basic control elements which are connected thereto, although it is not shown in FIG. 2. As shown in FIG. 6, a plurality of other control elements (an action control element 21a and a procedure element 21b) are connected to the branch element 21d, and one element as the branch destination is selected from these basic control elements to be executed. Furthermore, as shown in FIG. 6, a branch control element 22d (the details of which will be described later) serving as a custom processing element is connected to the branch element 21d.

(5) External Model Calling Element

The external model calling element corresponds to an element to which reference number 21e is given in FIG. 2. The external model calling element 21e is designed to call and execute another processing model. Furthermore, as shown in FIG. 2, the external model calling element 21e is connected to an action control element 21a serving as a basic control element.

Then, the custom processing elements will be described below.

Each of the custom processing elements is an element in which a separate function of the business processing executed in a business process (a requirement relating to business affairs, which must be satisfied by a basic control element, and small processing relating to business affairs or application systems, which is started under predetermined conditions) is implemented independent of a basic control element. Specifically, each of the custom processing elements executes the following processing: (a) executing processing, which is required by an application system, on the basis of a context, which is given from the application system, to return the results in the form of a desired object, (b) evaluating a context, which is given from an application system, on the basis of the specification of the application system to return an input data to the special execution sequence element, or (c) evaluating a context, which is given from an application system, on the basis of the specification of the application system to return any object of “null” or “non-null”. The custom processing elements include the following five kinds of elements.

(1) Action Element

The action element corresponds to an element to which reference number 22a is given in FIG. 2. Each of the action elements is designed to be called from the action control element 21a serving as a basic control element to execute a separate function of the business processing. As shown in FIGS. 2 and 3A, the action element 22a is connected to the action control element 21a serving as a basic control element.

(2) Post-Action Element

The post-action element corresponds to an element to which reference number 22b is given in FIG. 2. The post-action element is designed to execute post-processing which is carried out accompanying to the separate function of the business processing. As shown in FIGS. 2 and 3B, the post-action element 22b is connected to the action control element 21a serving as a basic control element, together with the action element 22a and the external model calling element 21e.

(3) Repetition Control Element

The repetition control element is designed to carry out a loop control (the control of the number of cycles, etc.) of the repeating procedure element 21c serving as a basic control element (see reference number 22c in FIG. 5B). As shown in FIG. 5B, the repetition control element 22c is connected to the repeating procedure element 21c serving as a basic control element, together with a plurality of basic control elements (an action control element 21a and a procedure element 21b) to be repeated. For example, in the repetition control element 22c, the number of cycles of the basic control elements (the action control element 21a and the procedure element 21b) is controlled. Furthermore, as shown in FIG. 5B, the repetition control element 22c is not always required for the repeating procedure element 21c, and the special execution sequence element 24 (the details of which will be described later) may be substituted for the repetition control element 22c.

(4) Branch Control Element

The branch control element is designed to carry out a branch control (the determination of a branch destination, etc.) of the branch element 21d serving as a basic control element (see reference number 22d in FIG. 6). As shown in FIG. 6, the branch control element 22d is connected to the branch element 21d serving as a basic control element, together with a plurality of basic control elements (an action control element 21a and a procedure element 21b) serving as branch destinations. In the branch control element 22d, a value is taken out of a specific key which is included in a context given from an application system, and a branch destination is determined by referring to branch labels (“branch destination 1” and “branch destination 2” shown in FIG. 6) given to basic control elements (the action control element 21a and the procedure element 21b) which are to be branch destinations.

(5) Exception Handler Element

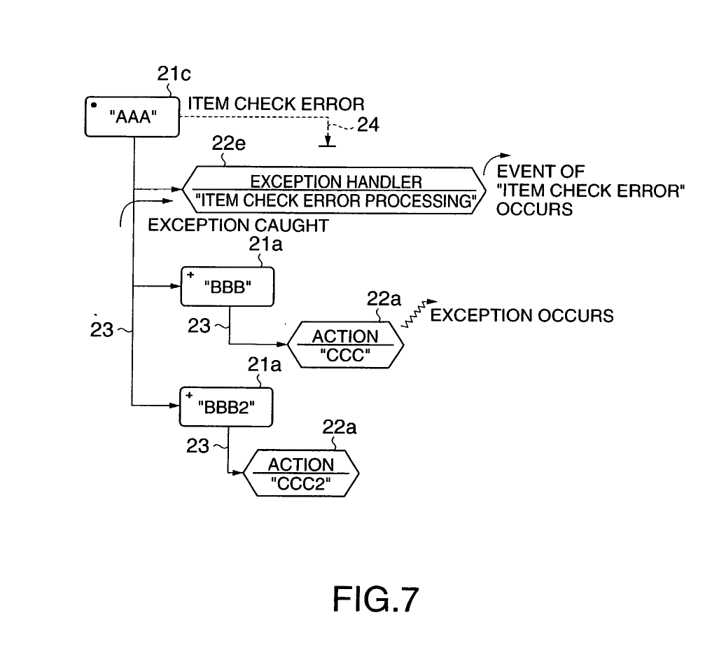

The exception handler element is designed to handle exceptions (errors on the processing of the application system, the fault of the system, etc.) which caused during the execution of the processing model (see reference number 22e in FIG. 7). As shown in FIG. 7, for example, the exception handler element 22e is connected to the repeating procedure element 21c, together with a plurality of action control elements 21a. The exception handler element 22e is designed to catch an exception which is caused during the execution of the action control element 21a, and to carry out a predetermined exception process (occurrence of an event “item check error” in the case of FIG. 7) with respect to the caught exception. The exception process can throw the caught exception again or throw a new exception in place of the caught exception, in addition to occurrence of the event. The exception handler element 22e may be connected to a desired basic control element.

Then, the normal execution sequence element 23 will be described below.

As shown in FIG. 2, the normal execution sequence element 23 is provided for connecting the basic control elements (21a, 21b, 21c, etc.) to each other and connecting the same to the custom processing elements (22a, 22b, etc.) in the form of a tree to form a regular execution route (the normal execution sequence element 23 will be also hereinafter referred to as a “structure line”).

Finally, the special execution sequence element 24 will be described below.

As shown in FIG. 2, the special execution sequence element 24 is designed to form an irregular execution route which does not comply with the regular execution route (the special execution sequence element 24 will be also hereinafter referred to as a “control line”) and which is determined on the basis of an event occurring in a basic control element (21a, 21b, 21c or the like) or a custom processing element (22a, 22b or the like). It is noted that an event name (“return”, “cancel” or the like shown in FIG. 2) serving as evaluation criteria for determining whether an irregular execution route is to be selected may be attached to the control line. If an event name is attached to the control line, evaluation of an event is carried out when the processing for the processing element to which the control line is connected ends; and then, it is determined whether an irregular execution route shown by the control line is determined or the procedure proceeds along a regular execution route shown by the structure line. On the other hand, if no event name is attached to the control line, an irregular execution route is unconditionally selected. Any one of various types of control lines may be used as the control line, and typical control lines are as follows.

(1) Control Line For “Retract”

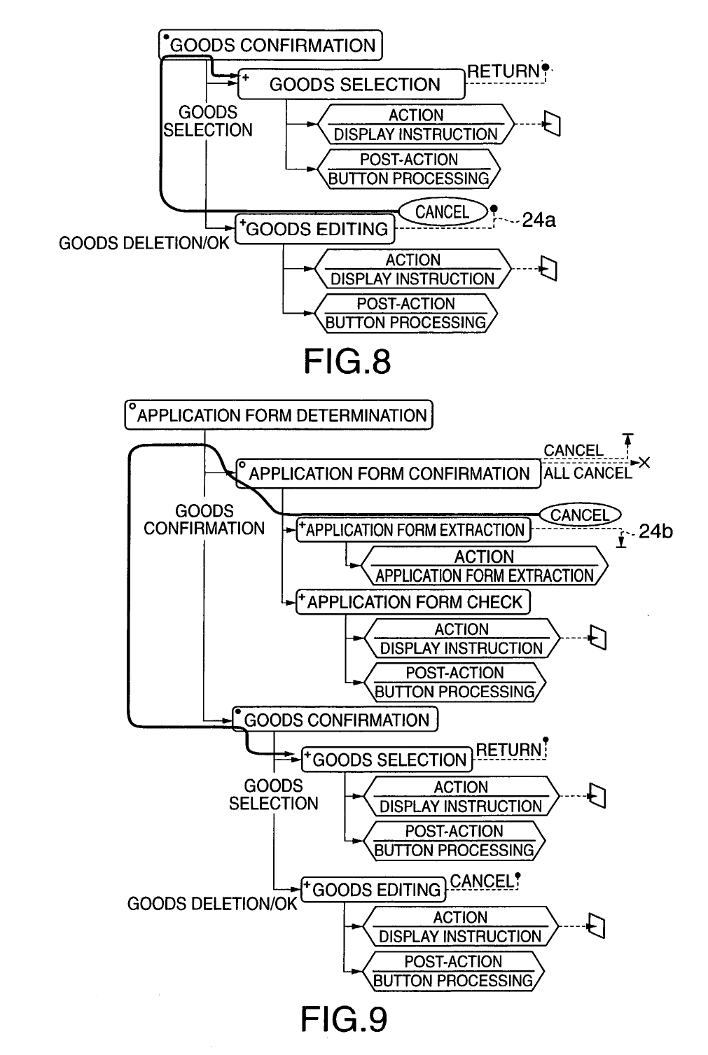

The control line for “retract” is a control line for carrying out processing (“retract” processing) for searching procedure elements or repeating procedure elements, which have called the present element, for an action control element that is one element before the present element in an execution sequence, and for transferring the control to the searched element. FIG. 8 is a diagram for explaining an example of the “retract” processing, wherein reference number 24a denotes a control line for “retract.” If an event “cancel” occurs while processing is carried out in the “goods editing” action control element, the “retract” processing is carried out to transfer the control to the “goods selecting” action control element that is one element before the present element in an execution sequence under “goods confirmation” repeating procedure element which has called the present element.

(2) Control Line For “Break”

The control line for “break” is a control line for carrying out processing (“break” processing) for ending the execution of a procedure element or a repeating procedure element, which has called the present element, and for continuing the execution. FIG. 9 is a diagram for explaining an example of the “break” processing, wherein reference number 24b denotes a control line for “break”. If an event “cancel” while processing is carried out in the “application form extraction” action control element of the “application form confirmation” procedure element, the “break” processing is carried out to end the execution of the “application form confirmation” procedure element which has called the present element, and to transfer the control to the “goods selecting” action control element of the “goods confirmation” repeating procedure element.

(3) Control Line For “Reverse Break”

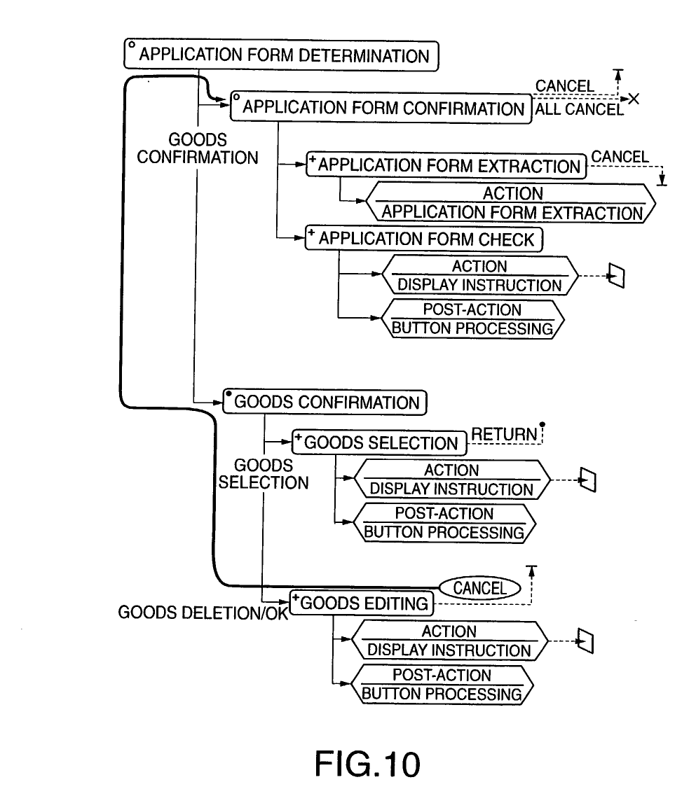

The control line for “reverse break” is a control line for carrying out processing (“reverse break” processing) for ending the execution of a procedure element or a repeating procedure element, which has called the present element, and for transferring the control to one processing element before the procedure element or the repeating procedure element as a caller in an execution sequence on the tree structure. FIG. 10 is a diagram for explaining an example of the “reverse break” processing, wherein reference number 24c denotes a control line for “reverse break.” If an event “cancel” occurs while processing is carried out in the “goods editing” action control element of the “goods confirmation” repeating procedure element, the “reverse break” processing is carried out to end the execution of the “goods confirmation” repeating procedure element which has called the present element, and to transfer the control to the “application form confirmation” procedure element, which is one element before the “goods confirmation” repeating procedure element in an execution sequence on the tree structure.

(4) Control Line For “Re-execute”

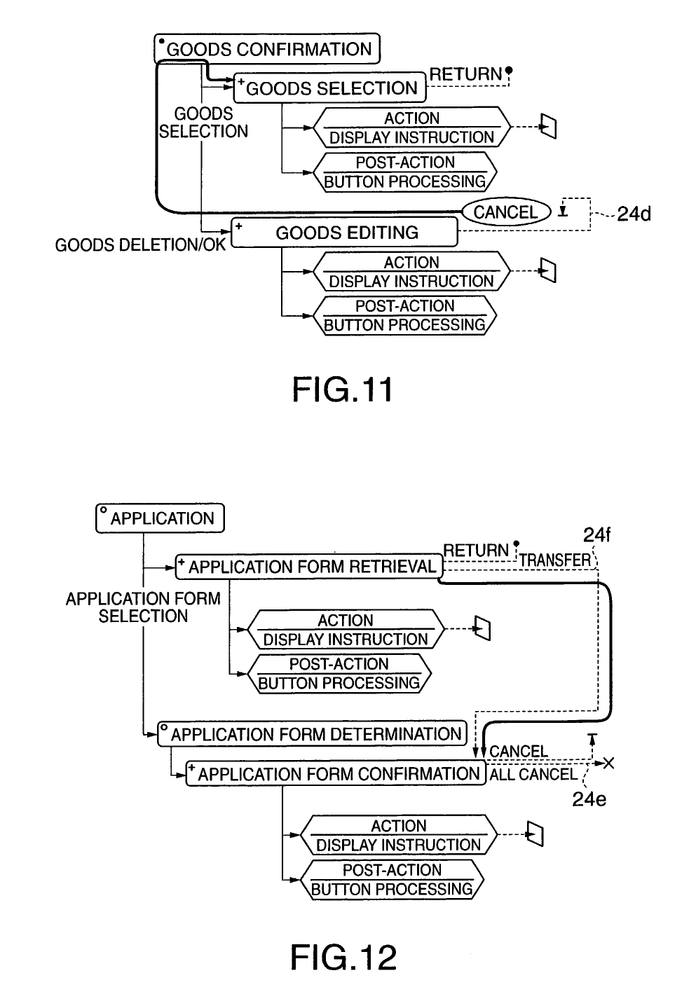

The control line for “re-execute” is a control line for carrying out processing (“re-execute” processing) for continuing execution from the top of the closest procedure element or repeating procedure element which has called the present element. FIG. 11 is a diagram for explaining an example of the “re-execute” processing, wherein reference number 24d denotes a control line for “re-execute.” If an event “cancel” occurs while processing is carried out in the “goods editing” action control element of the “goods confirmation” repeating procedure element, the “re-execute” processing is carried out to transfer the control to the closest “goods confirmation” repeating procedure element which has called the present element.

(5) Control Line For “End Of Execute”The control line for “end of execute” is a control line for carrying out processing (processing for “end of execute”) for ending a processing model. For example, in FIG. 12, reference number 24e denotes a control line for “end of execute, ” and a processing model ends if an event “all cancel” occurs while processing is carried out in the “application form confirmation” procedure element.

(6) Control Line For “Jump”

The control line for “jump” is a control line for carrying out processing (“jump” processing) for transferring the control from a certain processing element to any processing element in a processing model. FIG. 12 is a diagram for explaining an example of the “jump” processing, wherein reference number 24f denotes a control line for “jump.” If an event “transfer to application form confirmation action control element” occurs while processing is carried out in the “application form retrieval” action control element, the “jump” processing is carried out to transfer the control to the “application form retrieval” action control element.

(7) Others

Furthermore, in addition to the above-described control lines, there may be used (a) a control line for continuance for carrying out processing for starting the execution of the next processing element, (b) a control line for step out for carrying out processing for temporarily stopping the execution of a processing model to return to a calling source, and (c) a control line for procedure conclusion for carrying out processing for ending a most recently starting element of currently executed procedure element or repeating procedure element and for outputting an event occurring in the currently executed element. In addition, a plurality of control lines such as the above-described control lines may be connected to a single processing element.

Configuration of Business Process Development Support System

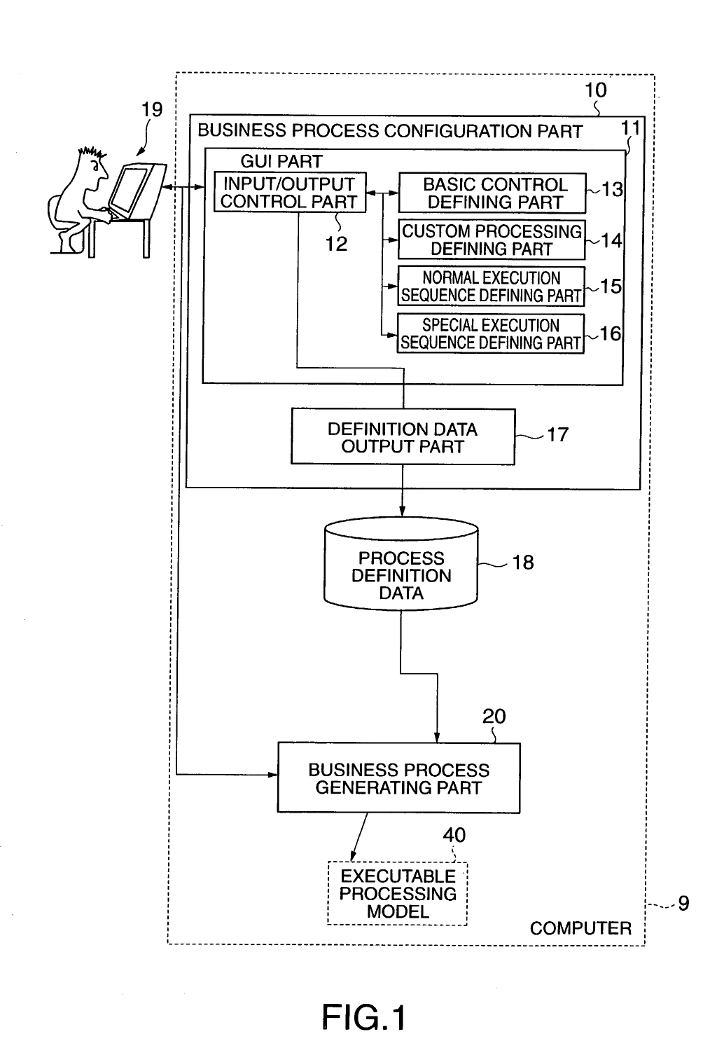

Referring to FIG. 1, the configuration of the business process development support system in this preferred embodiment will be described below.

As shown in FIG. 1, the business process development support system comprises: a business process configuration part 10 for modeling a process flow in a business process by connecting a plurality of processing elements and for outputting the results as a process definition data 18; and a business process generating part 20 for generating an executable processing model 40 on the basis of the process definition data 18 which is outputted from the business process configuration part 10. Both of the business process configuration part 10 and the business process generating part 20 are realized as software on a general purpose computer 9 to which an input/output unit 19 including a mouse, a keyboard, a display unit and so forth is connected. The number of computers 9 should not be limited to one, and the computer 9 may be connected to other computers and/or server having the same functions by communication means. Furthermore, if the computer 9 is connected to a server or the like, the computer 9 may generate a business process on the basis of an input from the server or the like. In this case, the input/output unit 19 is not always required.

The business process configuration part 10 has a GUI (Graphical User Interface) part 11 for displaying a plurality of processing elements as icons on a tool display via the input/output unit 19 and for modeling a process flow in a business process in accordance with various connecting operations to the displayed icons, which are carried out by the user. The business process configuration part 10 also has a definition data output part 17 for outputting the results of modeling such as information relating to declarations of integration of processing elements and relationship between processing elements, as the process definition data 18. The process definition data 18 outputted from the definition data output part 17 is recorded in a memory (not shown) of the computer 9, and is also stored in a secondary storage (not shown) on the basis of a user's request. The process definition data 18 may be described by the XML or the like.

The GUI part 11 includes: an input/output control part 12 for inputting/outputting control signals and data to and from the input/output unit 19; and a basic control defining part 13, a custom processing defining part 14, a normal execution sequence defining part 15 and a special execution defining part 16, which are connected to the input/output control part 12. The input/output control part 12 is designed to acquire an event which is inputted by operating the mouse included in the input/output unit 19, and deliver the event to any one of the basic control defining part 13, the custom processing defining part 14, the normal execution sequence defining part 15 and the special execution sequence defining part 16.

On the other hand, the business process generating part 20 is designed to automatically generate a program statement for realizing a process flow in the business process, on the basis of the process definition data 18 outputted from the business process configuration part 10, and for sequentially executing the process flow to generate an executable processing model 40 on the memory of the computer. Specifically, the basic control element and custom processing element included in the process definition data 18 are converted by the business process generating part 20 into a statement for generating an instance of a corresponding class. In addition, the custom processing element is converted into a statement for causing a basic control element, to which the custom processing element is connected, to hold the reference to the custom processing element. Moreover, the normal execution sequence element is converted into a statement for causing a basic control element, which corresponds to the starting point, to hold the reference to a basic control element or custom processing element, which corresponds to the end point. In addition, the special execution sequence element is converted into a statement for causing a basic processing element or custom processing element, to which the special execution sequence element is connected, to hold the reference to any element. If a business process is executed, processing is carried out by a method calling (method invocation) based on the reference. The business process generating part 20 may use a technique for generating an executable processing model on the basis of the process definition data 18 during execution, or a technique for previously generating a program statement on the basis of the process definition data 18 as a source code before execution and for executing an executable processing model, which has been generated on the basis of the source code, during execution.

Modeling of Business Process

Referring to FIG. 13, processing for modeling a process flow in a business process using the business process development support system shown in FIG. 1 will be described below.

FIG. 13 is a diagram showing an example of a tool display 30 which is displayed by the GUI part 11 of the business process configuration part 10 shown in FIG. 1. As shown in FIG. 13, the tool display 30 has a pallet region 31 and a canvas region 32.

In the pallet region 31, a plurality of icons 34 corresponding to basic control elements, and a plurality of icons 35 corresponding to custom processing elements are arranged. In the canvas region 32, a plurality of icons 34a and 35a applied on the basis of the icons 34 and 35 arranged in the pallet region 31 are arranged. The icons 34 and 35 arranged in the pallet region 31 correspond to the classes of basic control elements and custom processing elements constituting the business process to be developed, respectively; and the icons 34a and 35a arranged in the canvas region 32 correspond to the instances of the classes of the basic control elements and custom processing elements, respectively. In addition, in the pallet region 31 and canvas region 32, the basic control elements and custom processing elements are displayed as icons having different shapes, respectively.

The normal execution sequence elements are displayed as structure lines (solid lines) 36 for connecting the icons 34a corresponding to the basic control elements to each other, or for connecting the icons 34a corresponding to the basic control elements to the icons 35a corresponding to the custom processing elements. The special execution sequence elements are displayed as directed control lines (broken lines) 37 which are connected to the icons 34a and 35a corresponding to the basic control elements and custom processing elements. Furthermore, the control lines 37 are expressed by broken lines having different shapes every kind. If necessary, an event name serving as evaluation criteria for determining whether an irregular execution route is to be selected may be attached to the control line 37.

In such a tool display 30, the user operates the mouse or the like included in the input/output unit 19 for carrying out various operations to the icons (placing, moving, relating and copying of icons, pop-up of menu, etc.) on the tool display 30, to connect the icons 34a, 35a, the structure lines 36 and the control lines 37 in the canvas region 32 to model a process flow in the business process as a tree structure.

At this time, an event inputted by operating the mouse or the like is acquired by the input/output control part 12 of the GUI part 11, and the event is delivered to any one of the basic control defining part 13, the custom processing defining part 14, the normal execution sequence defining part 15 and the special execution sequence defining part 16. Data of a predetermined format ({kind of event}) is delivered between the input/output control part 12, the basic control defining part 16, the custom processing defining part 14, the normal execution sequence defining part 15 and the special execution sequence defining part 16.

Thereafter, predetermined processing based on the delivered event is carried out in the basic control defining part 13, custom processing defining part 14, normal execution defining part 15 or special execution sequence defining part 16, to which the event has been delivered.

Specifically, for example, if the user operates the mouse or the like in the tool display 30 shown in FIG. 13, to arrange the icon 34, which corresponds to the basic control element of the icons arranged in the pallet region 31, as an icon 34a in the canvas region 32 (see (A) in FIG. 13), it is declared by the basic control defining part 13 that the flow of control of the basic control element is integrated into the business process.

In addition, if the user operates the mouse or the like to arrange the icon 35, which corresponds to the custom processing element of the icons arranged in the pallet region 31, as an icon 35a so that the icon 35a is connected to the icon 34a corresponding to the basic control element in the canvas region 32 (see (B) in FIG. 13), it is declared by the custom processing defining part 14 that the separate functions of the custom processing element are integrated into the business process. Furthermore, the integration of the custom processing element can also be declared by popping-up the dialog of the icon 34a corresponding to the basic control element serving as an integration destination by operating the mouse or the like and by inputting the identifier of the custom processing element to the popped-up dialog.

Moreover, if the user connects the icons 34a corresponding to the basic control elements to each other, or connects the icons 34a corresponding to the basic control elements to the icons 35a corresponding to the custom processing elements, by the structure lines 36 (corresponding to the normal execution sequence elements), by operating the mouse or the like (see (C) in FIG. 13), an execution route extending from a basic control elements serving as a starting point to a basic control element or custom processing element serving as an end point is formed by the normal execution sequence defining part 15.

In addition, if the user arranges the control line 37 (corresponding to the special execution sequence element) so that the control line 37 is connected to the icon 34a or 35a corresponding to a basic control element or custom processing element (see (D) in FIG. 13), an irregular execution route extending from a basic control element or custom processing element serving as a connection source is formed by the special execution sequence defining part 16.

The results of processing carried out by the basic control defining part 13, custom processing defining part 14, normal execution sequence defining part 15 and special execution sequence defining part 16 are recorded in the memory (not shown) of the computer 9 as the process definition data 18 by the definition data output part 17 via the input/output control part 12. At this time, the format of data delivered between the input/output control part 12 and the definition data output part 17 is as follows.

In the case of recording from the basic control defining part 13: {the kind of a basic control element, an identifier, a property value*}

In the case of recording from the custom processing defining part 14: {the kind of a custom processing element, an identifier, a property value*, the identifier of a basic control element serving as a connection destination}

In the case of recording from the normal execution sequence defining part 15: {the identifier of a basic control element serving as a starting point, the identifier of a basic control element or custom processing element serving as an end point}

In the case of recording from the special execution sequence defining part 16: {the identifier of a basic processing element or custom processing element serving as a connection destination}

Generation of Business Process

Processing for generating a business process thus modeled will be described below.

The business process generating part 20 automatically generates a program statement for realizing a process flow in a business process, on the basis of the process definition data 18, and sequentially executes the program statement to generate an executable processing model 40 in the memory of the computer.

Execution of Function of Business Process

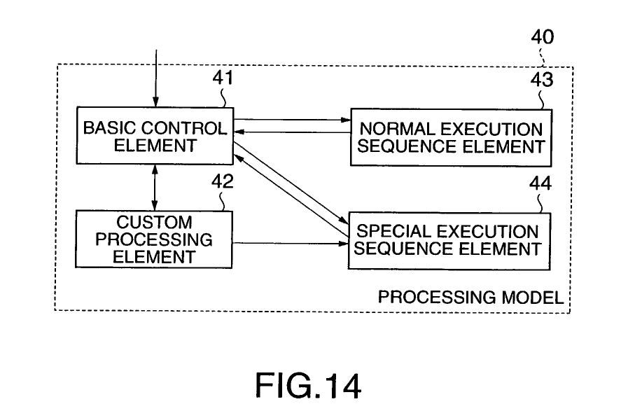

Finally, referring to FIGS. 14 through 20, processing for executing the function of the executable processing model 40 thus generated will be described below.

If the user operates the input/output unit 19 for making a request for execution of a function, to the generated executable processing model 40 of the business process, processing for executing the function is carried out by the processing model 40.

FIG. 14 is a diagram for explaining processing for executing the function of a business process. It is noted that FIG. 14 shows the structure of the processing model 40 as the relationship between the classes of the basic control element, the custom processing element, the normal execution sequence element and the special execution sequence element.

As shown in FIG. 14, a request for execution of a function is first delivered to a basic control element class 41 serving as a starting point for the processing model 40.

In the basic control element class 41, it is verified whether a custom processing element class 42 is added at a predetermined place during the execution of the processing. If it is added, a calling is made to the added custom processing element class 42 via a predefined interface. In addition, it is verified whether the special execution, sequence element class 44 is added at a predetermined place. If it is added, a calling is made to the added special execution sequence element class 44 via a predefined interface. Moreover, it is verified whether a normal execution sequence element class 43 is added at a predetermined place. If it is added, a calling is made to the added normal execution sequence element class 43 via a predefined interface. After the processing goes to the custom processing element class 42 or the normal execution sequence element class 43 and ends the processing therein to return to the basic control element class 41 again, the remaining processing in the basic control element class 41 is carried out. With respect to the special execution sequence element class 44, the remaining processing in the basic control element class 41 is omitted after the processing goes to a calling destination. It is noted that the transfer to the custom processing element class 42, the special execution sequence element class 44 and the normal execution sequence element class 43 are carried out in that order.

In the custom processing element class 42, it is verified whether a special execution sequence element class 44 is added at a predetermined place during the execution of the processing. If it is added, a calling is made to the added special execution sequence class 44 via a predefined interface. After the processing goes to a calling destination, the remaining processing in the basic control element class 41 is omitted. The results of the processing carried out by the custom processing element class 42 are returned to the basic control element class 41.

In the normal execution sequence element class 43, a calling is made to the basic control element class 41 in the processing model 40, which is assigned by the normal execution sequence element class 43, via a predefined interface.

In the above-described processing for executing the function, a sequence for calling the basic control element class 41, the custom processing element class 42, the normal execution sequence element class 43 and the special execution sequence element class 44 can be realized by managing the instance of the basic control element classes 41 (the instances corresponding to the basic control elements) by a stack or the like. That is, by acquiring a reference to a calling destination by a predetermined operation for a stack, it is possible to realize processing according to the special execution sequence element (control line) (retract, break, reverse break, re-execute of procedure, end of execute, jump or the like) as well as processing according to the normal execution sequence element (structure line).

As an example of a method for realizing processing for executing the function by utilizing a stack, the order entry determination processing model shown in FIG. 2 will be described below. In the following description, kind of the relationship between the “application” procedure element and the “application form retrieval” action control element is a “parent-child” relationship (in this case, the “application” procedure element is a “parent”, and the “application form retrieval” action control element is a “child”); and kind of the relationship between the “application form retrieval” action control element and the “application form determination” procedure element is a “brother” relationship (in this case, the “application form retrieval” action control element is an “elder brother”, and the “application form determination” procedure element is a “younger brother”).

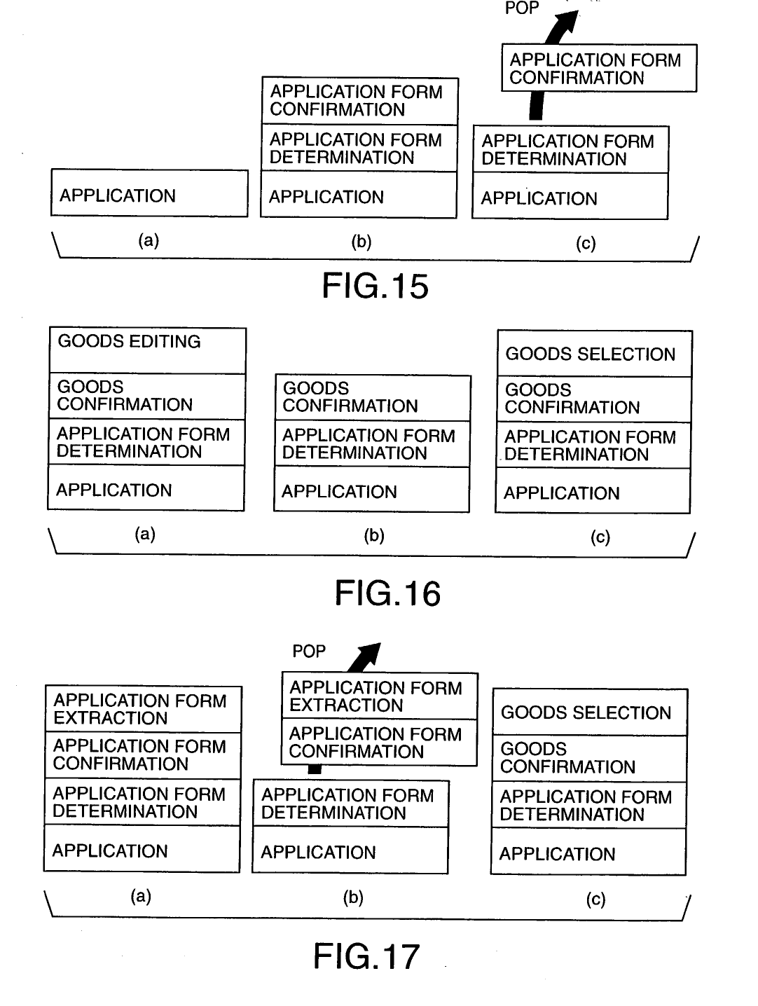

First, referring to FIGS. 15(a), 15(b) and 15(c), an example of processing according to a normal execution sequence element (a structure element) will be described below.

Now, if the order entry determination processing shown in FIG. 2 is carried out, the “application” procedure element is first pushed to a stack as shown in FIG. 15(a). Then, the “application form determination” procedure element being a child of the “application” is pushed to the stack; and furthermore, the “application form confirmation” procedure element being a child of the “application form determination” procedure element is pushed to the stack (FIG. 15(b)). Then, the “application form confirmation” procedure element is executed. If this ends, the “application form confirmation” procedure element is popped from the stack (FIG. 15(c)). Thereafter, the “goods confirmation” repeating procedure element being a younger brother element of the “application form confirmation” procedure element is pushed to the stack, and the same procedure is carried out.

An example of processing according to the special execution sequence element (a control line) (retract, break, reverse break, re-execute of procedure, end of execute, and jump) will be described below.

First, referring to FIGS. 16(a), 16(b) and 16(c), an example of “retract” processing will be described below. The “retract” processing is processing for searching procedure elements, which have called the present element, for an action control element that is one element before the present element in an execution sequence, and for transferring the control to the searched element. As shown in FIG. 8, there is now considered a case where the “retract” processing is carried out while processing in the “goods editing” action control element is carried out. When the processing in the “goods editing” action control element is carried out, the stack is in a state shown in FIG. 16(a). If the “retract” processing is indicated in this state, the “goods editing” action control element is first popped from the stack (FIG. 16(b)). Then, it inquires of the “goods confirmation” repeating procedure element serving as a parent element whether an action control element exists immediately before the “goods editing” action control element. Then, the “goods confirmation” repeating procedure element answers that the “goods selecting” action control element exists. Then, the “goods selecting” action control element is pushed to the stack (FIG. 16(c)) to start processing.

Referring to FIGS. 17(a), 17(b) and 17(c), an example of “break” processing will be described below. The “break” processing is processing for ending the execution of a procedure element or the like, which has called the present element, and for continuing the execution. As shown in FIG. 9, there is now considered a case where the “break” processing is carried out while the “application form extraction” action control element of the “application form confirmation” procedure element is carried out. When processing in the “application form extraction” action control element is carried out, the stack is in a state shown in FIG. 17(a). If the “break” processing is indicated in this state, the “application form extraction” action control element being the present element, and the “application form confirmation” procedure element being a parent element of the present element are popped from the stack (FIG. 17(b)). At this time, it inquires of the “application form confirmation” procedure element being the parent element what is a younger brother element with respect to the parent element. The parent element further inquires of the “application form determination” procedure element being the parent element of the present element what is a younger brother element of the present element, and acquires that the younger brother element is the “goods confirmation” repeating procedure element. Then, the “goods confirmation” repeating procedure element is pushed to the stack, and the “goods selecting” action control element being a child element is also pushed (FIG. 17(c)), so that processing starts.

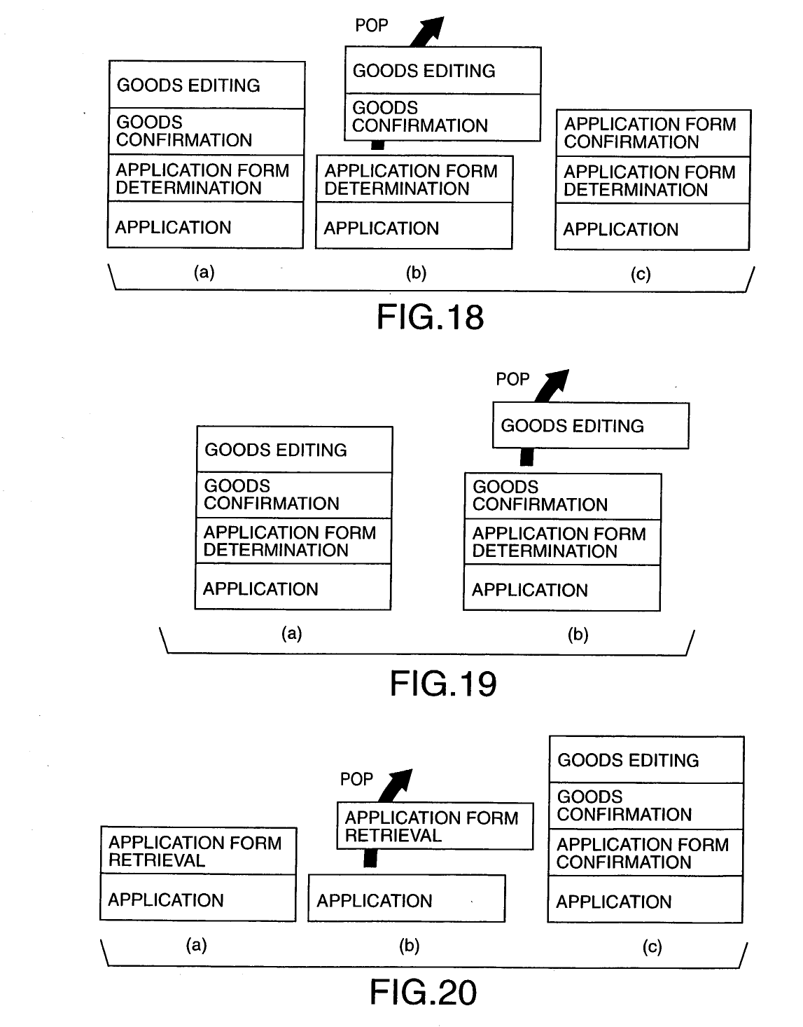

Referring to FIGS. 18(a), 18(b) and 18(c), an example of “reverse break” processing will be described below. The “reverse break” processing is processing for ending the execution of a procedure element or the like, which has called the present element, and for transferring the control to one processing element before the procedure element or the like as a caller in an execution sequence on a tree structure. As shown in FIG. 10, there is now considered a case where the “reverse break” processing is carried out while processing in the “goods editing” action control element of the “goods confirmation” repeating procedure element is carried out. When processing in the “goods editing” action control element is carried out, the stack is in a state shown in FIG. 18(a). If the “reverse break” processing is indicated in this state, a “goods editing” action control element being the present element, and the “goods confirmation” repeating procedure element being a parent element of the present element are popped from the stack (FIG. 18(b)). Then, the present element inquires of the “goods confirmation” repeating procedure element being the parent element what is an elder brother element with respect to the parent element. The parent element further inquires of the “application form determination” procedure element being a parent element of the present element what is an elder brother element of the present element, and obtains an answer that the elder brother element is the “application form confirmation” procedure element. Then, the “application form confirmation” procedure element is pushed to the stack (FIG. 18(c)) to start the processing for the “application form confirmation” procedure element.

Referring to FIGS. 19(a) and 19(b), an example of “re-execute” processing will be described below. The “re-execute” processing is processing for continuing execution from the top of the closest procedure element or the like which has called the present element. As shown in FIG. 11, there is now considered a case where the “re-execute” processing is carried out while processing in the “goods editing” action control element is carried out. When processing is carried out in the “goods editing” action control element, the stack is in a state shown in FIG. 19(a). If the “re-execute” processing is indicated in this state, the “goods editing” action control element is popped from the stack (FIG. 19(b). Then, processing for the “goods confirmation” repeating procedure element starts in the stack, i.e., procedure processing closest to the present element is re-executed.

Finally, referring to FIG. 20(a), 20(b) and 20(c), an example of “jump” processing will be described below. The “jump” processing is processing for transferring the control from a certain processing element to any processing element in a processing model. As shown in FIG. 12, there is now considered a case where the “jump” processing is carried out while processing is carried out in the “application form retrieval” action control element. When processing is carried out in the “application form retrieval” action control element, the stack is in a state shown in FIG. 20(a). The contents of the “jump” processing includes information about “to which processing element” the control is transferred. In this case, it is assumed that information that the control is transferred to the “application form confirmation” processing element is included, and that the “jump” processing is carried out. Then, the “application form retrieval” action control element of the present element is popped from the stack (FIG. 20(b)), and the “application form confirmation” procedure element being a processing element of a transfer destination is pushed to the stack (FIG. 20(c)). Thus, the “application form confirmation” procedure element is executed, and the processing is transferred from the processing in the “application form retrieval” action control element to the processing in the “application form confirmation” procedure element. If the procedure in the “application form confirmation” procedure element ends, it is popped from the stack, and the stack is in a state shown in FIG. 20(a). Then, the “application form retrieval” action control element is pushed to carry out processing.

In order to attain a brother element of the present element, a method for attaining a brother element of the present element by allowing the present element to inquire of a parent element while the parent element of the present element already holds the brother element of its own, or a method for attaining a brother element of the present element while brother elements already hold elements which are paired therewith, may be used.

Thus, according to this preferred embodiment, a process flow in a business process is modeled by connecting processing elements (basic control elements, custom processing elements, normal execution sequence elements and special execution sequence elements, etc.) which are formed as components, and an executable processing model is generated on the basis of such a modeling. Therefore, it is possible to model the process flow in the business process in a visualized manner, and it is possible to directly generate and execute the business process without the need of particularly additional implementations for the modeled business process. For that reason, it is possible to efficiently carry out the development and maintenance of the business process.

While the execution sequence elements (the normal execution sequence elements and the special execution sequence elements) have been provided in addition to the basic control elements or custom processing elements in the above-described preferred embodiment, the basic control elements or custom processing elements may directly call another basic control element via interfaces.

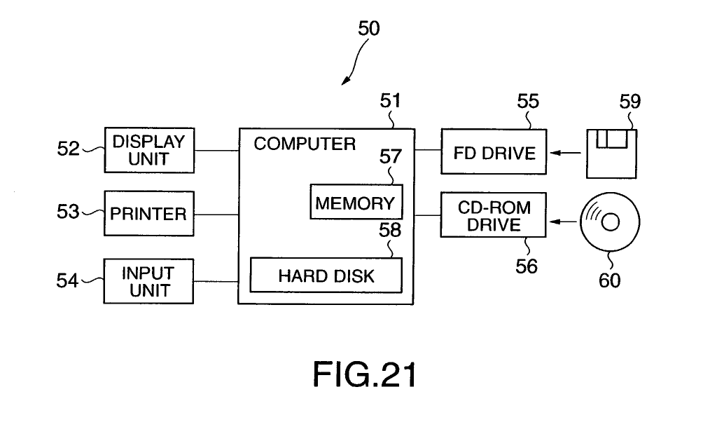

Furthermore, in the above-described preferred embodiment, both of the business process configuration part 10 and the business process generating part 20 may be realized as software on a computer system 50 shown in FIG. 21. In addition, a business process developing framework including the class libraries and so forth of processing elements (basic control elements, custom processing elements, normal execution sequence elements and special execution sequence elements) may be installed in the computer system shown in FIG. 21. The computer system 50 comprises various peripheral apparatuses, such as a display unit 52 including a CRT, an input unit 54 including a keyboard and a mouse, an FD drive 55, a CD-ROM drive 56, and a hard disk unit 58, in addition to a computer 51. A program including the above-described program module may be stored in a computer-readable recording medium, such as a memory 57 or hard disk 58 in the computer 51, a flexible disk 59, or a CD-ROM 60, and the program can be sequentially read by a CPU (Central Processing Unit) of the computer 51 to be executed to realize the above-described functions.

Furthermore, recording media according to the present invention should not be limited to flexible disks and CD-ROMs, and may be recording media having any recording forms, such as magnetic disks, internal memories, hard disks, optical disks (CD-R, DVD (Digital Versatile Disk), etc.), optical magnetic disks (MO (Magneto Optical), etc.), and semiconductor memories, which can record programs and which can be read by computers. In addition, the recording media include carrier waves, which are used for transmission on a network, and information transmission media.

In addition, an MW (middleware), such as an OS (operating system), a data base managing software or a network software, which operates on a computer on the basis of instructions of a program installed in the computer from a recording medium, may execute a part of the business processing for realizing the present invention.

Moreover, recording media according to the present invention should not be limited to media independent of computers, and include recording media in which a program transferred by LAN or Internet is downloaded to be stored or temporarily stored.

In addition, the number of recording media according to the present invention should not be limited to one, and include a plurality of recording media from which processing according to the present invention is executed. The constructions of recording media may be any constructions.

What is claimed is:

1. A system of supporting a development of a business process that executes a series of business processing, the system comprising:
a business process configuration part for modeling a process flow in the business process by connecting a plurality of processing elements, to output a process definition data as a result of the modeling; and
a business process generating part for generating an executable processing model by using the process definition data outputted from the business process configuration part,
wherein the plurality of processing elements include a plurality of basic control elements in which basic control flows of the series of business processing executed in the business process are implemented, and a plurality of custom processing elements in which separate functions of the series of business processing executed in the business process are implemented, and
the business process configuration part models the process flow in the business process by forming a regular execution route through connecting the basic control elements to each other and connecting the basic control elements to the custom processing elements in a form of a tree, and by forming an irregular execution route that does not comply with the regular execution route and is determined on the basis of an event occurring in the basic control elements or the custom processing elements.

2. The system according to claim 1, wherein the plurality of processing elements further include a plurality of normal execution sequence elements for forming the regular execution route, and a plurality of special execution sequence elements for forming the irregular execution route, and
the business process configuration part models the process flow in the business process by connecting the normal execution sequence elements and the special execution sequence elements together with the basic control elements and the custom processing elements.

3. The system according to claim 1, wherein the plurality of basic control elements comprise an action control element for executing a custom processing element connected thereto; a procedure element for executing a plurality of other basic control elements connected thereto in a predetermined sequence; and a repeating procedure element for repeatedly executing a plurality of other basic control elements connected thereto in a predetermined sequence.

4. The system according to claim 3, wherein the plurality of basic control elements further comprise a branch element for selecting and executing an element as a branch destination among a plurality of other basic control elements connected thereto.

5. The system according to claim 3, wherein the plurality of basic control elements further comprise an external model calling element for calling and executing another processing model.

6. The system according to claim 1, wherein the business process configuration part presents the plurality of processing elements as icons on a tool display, and models the process flow in the business process in accordance with various connecting operations to the icons carried out by a user.

7. A method of supporting a development of a business process that executes a series of business processing, the method comprising the steps of:
preparing, as a plurality of processing elements for modeling a process flow in the business process, a plurality of basic control elements in which basic control flows of the series of business processing executed in the business process are implemented, and a plurality of custom processing elements in which separate functions of the series of business processing executed in the business process are implemented;
modeling the process flow in the business process by forming a regular execution route through connecting the basic control elements to each other and connecting the basic control elements to the custom processing elements in a form of a tree, and by forming an irregular execution route that does not comply with the regular execution route and is determined on the basis of an event occurring in the basic control elements or the custom processing elements; and
outputting, as a process definition data, information relating to declarations for integrating the processing elements and relationship between the processing elements.

8. The method according to claim 7, further comprising the step of generating an executable processing model by using the outputted process definition data.

9. The method according to claim 7, wherein the plurality of basic control elements comprise an action control element for executing a custom processing element connected thereto; a procedure element for executing a plurality of other basic control elements connected thereto in a predetermined sequence; and a repeating procedure element for repeatedly executing a plurality of other basic control elements connected thereto in a predetermined sequence.

10. The method according to claim 9, wherein the plurality of basic control elements further comprise a branch element for selecting and executing an element as a branch destination among a plurality of other basic control elements connected thereto.

11. The method according to claim 9, wherein the plurality of basic control elements further comprise an external model calling element for calling and executing another processing model.

12. The method according to claim 7, wherein the plurality of processing elements are presented as icons on a tool display, and the process flow in the business process is modeled in accordance with various connecting operations to the icons carried out by a user.

13. A computer-readable recording medium in which a program of supporting a development of a business process that executes a series of business processing is recorded, the program causing a computer to perform the steps of:
preparing, as a plurality of processing elements for modeling a process flow in the business process, a plurality of basic control elements in which basic control flows of the series of business processing executed in the business process are implemented, and a plurality of custom processing elements in which separate functions of the series of business processing executed in the business process are implemented;
modeling the process flow in the business process by forming a regular execution route through connecting the basic control elements to each other and connecting the basic control elements to the custom processing elements in a form of a tree, and by forming an irregular execution route that does not comply with the regular execution route and is determined on the basis of an event occurring in the basic control elements or the custom processing elements; and
outputting, as a process definition data, information relating to declarations for integrating the processing elements and relationship between the processing elements.

14. The computer-readable recording medium according to claim 13, the program further causing the computer to perform the step of generating an executable processing model by using the outputted process definition data.

15. The computer-readable recording medium according to claim 13, wherein the plurality of basic control elements comprise an action control element for executing a custom processing element connected thereto; a procedure element for executing a plurality of other basic control elements connected thereto in a predetermined sequence; and a repeating procedure element for repeatedly executing a plurality of other basic control elements connected thereto in a predetermined sequence.

16. The computer-readable recording medium according to claim 15, wherein the plurality of basic control elements further comprise a branch element for selecting and executing an element as a branch destination among a plurality of other basic control elements connected thereto.

17. The computer-readable recording medium according to claim 15, wherein the plurality of basic control elements further comprise an external model calling element for calling and executing another processing model.

18. The computer-readable recording medium according to claim 13, wherein the plurality of processing elements are presented as icons on a tool display, and the process flow in the business process is modeled in accordance with various connecting operations to icons carried out by a user.
